(19) United States
(12) Patent Application Publication
(10) Pub. No.: US 2004/0212980 A1
(43) Pub. Date: Oct. 28, 2004

(54) Illuminated sports board riser

(76) Inventor: Randall Wells, Cumming, GA (US)

Correspondence Address: Randall Wells, 1810 Rising Mist Lane, Cumming, GA, 30041, US

(21) Appl. No.: 10/422,896

(22) Filed: Apr. 24, 2003

(51) Int. Cl. F21V 7/04

(52) U.S. Cl. 362/31

(57) ABSTRACT

An illuminated sports board riser consists of a translucent material such as frosted clear acrylic or resin based material, one or more LED's, a power source, an electrical circuit consisting of an on-off switch to control the power between the LED's and an power source, and a resister to regulate voltage based on the voltage of the power source and the voltage of the LED.

### CROSS REFERENCE TO RELATED APPLICATIONS

| Number | Date | Inventors | U.S. Class |
|---|---|---|---|
| 4,997,196 | March 1991 | Wood | 362/800 |
| 5,067,058 | November 1991 | Standley | 362/190 |
| 5,119,277 | June 1992 | Copley et al. | 280/87 |
| 5,292,141 | March 1994 | Ekedal et al. | 280/87 |
| 6,431,733 | August 2002 | Seifert et al. | 362/459 |

### STATEMENT REGARDING FED SPONSORED R&D

Not Applicable.

### REFERENCE TO SEQUENCE LISTING, OR A TABLE

Not Applicable.

### BACKGROUND OF THE INVENTION

This invention relates primarily to Ski's, Snowboard's, Snow Skate's, Skateboard's, along with other sport related boards.

The following art defines the present state of this field:

Wood, U.S. Pat. No. 4,997,196, specifies an illuminated skateboard that includes a string of LED's embedded in a groove located on the perimeter of the skateboard. The LED's are controlled by a micro controller mounted upon the bottom surface of the board.

Ekedal et al, U.S. Pat. No. 5,292,141, describes a skateboard that includes a rotate-able disk mounted upon the top surface of the skateboard's riding surface. It also describes a housing that is placed under the board and contains an illuminated enclosure forward of the front truck and rearward of the rear truck. Similar systems are taught in Copley et al., U.S. Pat No. 5,119,277, and Standley, U.S. Pat. No. 5,067,058.

Seifert et al, U.S. Pat. No. 6,431,733, describes an illuminated sports board that contains an electro-luminescent sheet mounted with-in the sports board. A micro controller mounted upon the top surface of the board controls the power to the electro-luminescent sheet. It describes the electro-luminescent sheet as being viewable from the top or bottom of the sports board.

The prior art specifies skateboards and sports boards that include lights mounted upon the board either in a string, with-in a housing or a sports board in which the illumination is directed in only one or two directions. However, the prior art does not specify the construction of an illuminated translucent riser plate that is constructed with-in or as part of the sports board. Nor does the prior art specify the construction of an illuminated translucent riser plate that is constructed to be mounted between the sports board and the trucks or bindings. The prior art does not discuss Ski, Snowboard or Snow skate related bindings and brackets. The present invention fulfills these needs and provides further related advantages as described in the following summary.

### BRIEF SUMMARY OF THE INVENTION

The present invention specifies an illuminated sports board riser. An illuminated sports board riser can be used for Ski's, Snowboard's, Snow Skate's, Skateboard's, along with other sport related boards. When related to Skis and snowboards the riser is typically placed under the binding. The riser can also be built into the Snowboard, Ski or binding. When related to a Snow Skate or Skateboard the riser would be located between the truck and the board. The illuminated riser consists of a translucent material such as frosted clear acrylic, one or more LED's, a power source, a on-off switch to control the power to the LED's and if needed a resister to control voltage.

A primary objective of the present invention is to provide an illuminated riser having advantages not specified in prior art.

Another objective is to provide an eye-catching decorative feature for sports boards and risers related to sports boards, useful for decoration, advertising and visual safety.

Other features and advantages of the present invention will be specified further in the following detailed descriptions, when taken in context with the accompanying drawings. The accompanying drawings will, illustrate the principles of the invention, by way of example.

### BRIEF DESCRIPTION OF THE DRAWINGS

The accompanying drawings illustrate the present invention. In which:

FIG. 1 is a exploded perspective view of a snowboard embodying the present invention;

FIG. 2 is a perspective view of a snowboard with a built-in riser embodying the present invention;

FIG. 3 is a top view of riser;

FIG. 4 is a bottom plan view of riser;

FIG. 5 is a side elevation of a snowboard with built-in risers;

FIG. 6 is a side elevation of a binding embodying the present invention;

FIG. 7 is a side elevation of a skateboard embodying the present invention;

### DETAILED DESCRIPTION

The above described drawings figures illustrate the invention, an illuminated sports board riser 3, 6, 7, 12,14, 18 and 21 that is designed to be placed either between the sports board (i.e. skateboard, snow skate, snowboard, wakeboard, surfboard, or the like) and the sports board rider/bindings or the sports board and the surface the sports board is ridden upon as shown in FIG. 7. It includes a means to illuminate the material of the riser.

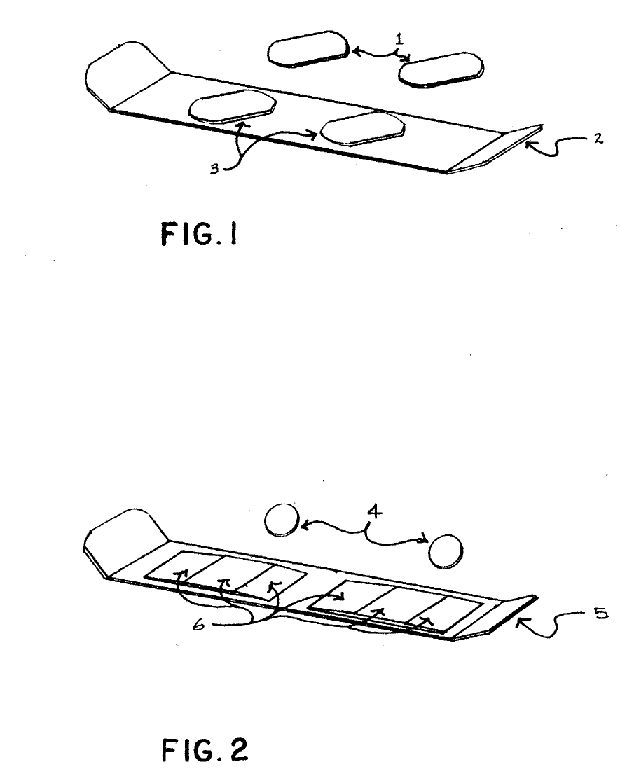

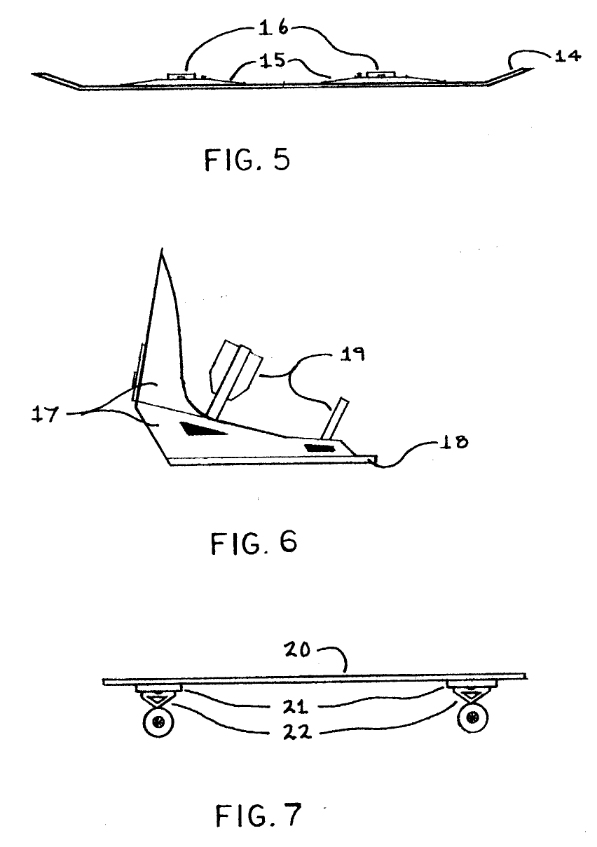

As shown in FIGS. 1-7, the illuminated sports board riser includes a transparent/translucent plane 3, 6, 15, 18 and 21that allows transmission of light to the outer surfaces of the riser from the light source 8 embedded in the transparent/translucent plane. In the case of a snowboard 2 the riser 3 is located between the snowboard 2 and the snowboard bindings 1. In the case of a snowboard 5 with built-in risers 6 the riser is a part of the board and is typically molded into the board 5 and the bindings 4 are mounted on top of the risers 6.

Other components included within the illuminated sports board riser 3, 6, 7, 12, 14, 18 and 21 could include a light source 8 which is preferably an LED, a on/off switch 10, a power source 11 and a electrical circuit 13 to connect the power source 11 to the on/off switch 10 and from the on/off switch 10 to the light source then from the light source 8 to the power source 11 to complete the electrical circuit 13. Any or all of the mentioned components 8, 10, 11 or 13 could be located outside of the riser 3, 6, 7, 12, 14, 18 and 21 inside another body as long as a method to transmit light into the plane is devised thru reflection or projection from a light source. However the preferred method would contain all components with the riser 3, 6, 7, 12, 14, 18 and 21.

When the riser components 8, 10, 11 and 13 are embedded with-in the riser, the riser 3, 6, 7, 12, 14, 18 and 21must be molded or tooled to accommodate any component 8, 10, 11 and 13 that is to be placed within the riser. After the components 8, 10, 11 and 13 are assembled and placed into the riser the components 8, 10 and 13 should be enclosed using a waterproof translucent/transparent material (i.e. resin, silicon sealant). The power source 11 should not be permanently enclosed unless there is a method provided to recharge it. The power source 11 should be shielded from the elements with via a sealable screw-on cap or an adhesive cover that prevent water or dust from entering the power source compartment. Those skilled in the art, can of course, select alternant and equivalent materials that are equally useful in the practice of this invention and such alternant materials should be considered within the scope of the claimed invention.

The on/off switch 10 operates to control the power from the power source 11 to the light source 8. The power source 11 is preferably a coin type battery which matches the power requirements of the light source. The power supplied by the power source 11 may be limited by a resistor or other method within the electrical circuit. Those skilled in the art can devise many versions or the electrical circuit 13 to control the light source 8.

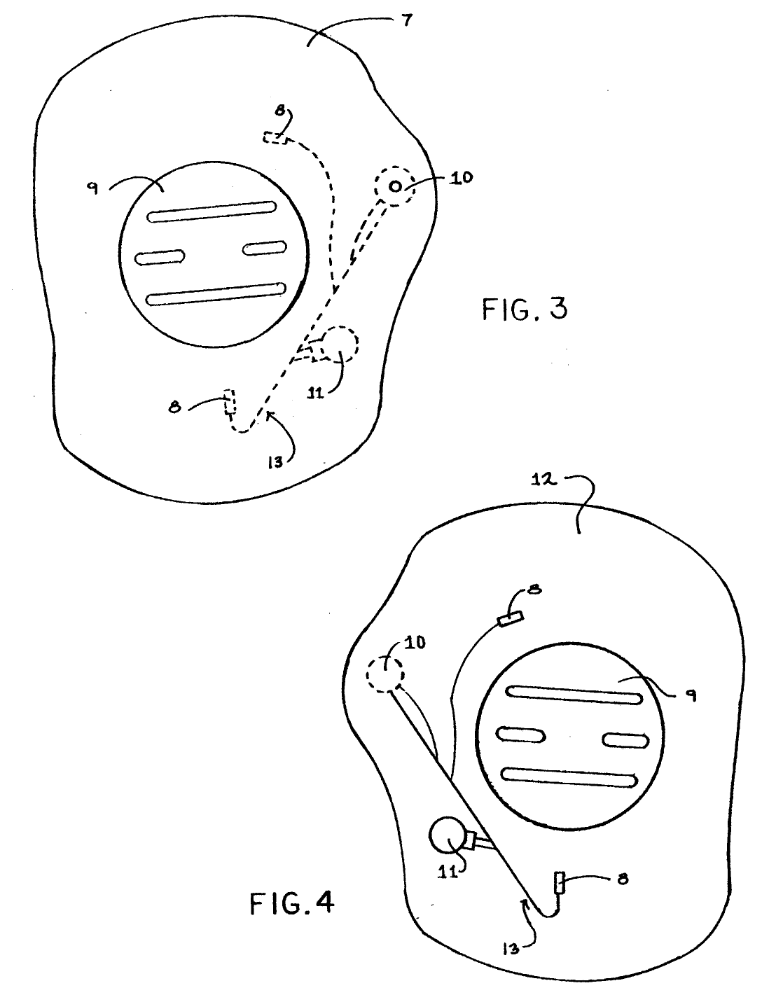

As shown in FIGS. 3 and 4 the riser 7 and 12 can incorporate an adjustable disc 9 to allow the riser to rotate as needed during the installation process to align with the binding or other device.

In a first embodiment, as shown in FIGS. 1, 2 and 5 the illuminated sports board riser 3 includes a translucent/transparent plane. The translucent/transparent plane is preferably acrylic or thermo-molded plastic. The embodiment may also include all components 8, 10, 11 and 13.

In an alternate embodiment, as shown in FIG. 6 the illuminated sports board riser 18 is part of a binding and includes a translucent/transparent plane. The translucent/transparent plane is preferably acrylic or thermo-molded plastic. The embodiment may also include all components 8, 10, 11 and 13.

In a final embodiment, as shown in FIG. 7 the illuminated sports board riser 21 is mounted below the sports board 20 and includes a translucent/transparent plane. The translucent/transparent plane is preferably acrylic or thermo-molded plastic. The embodiment may also include all components 8, 10, 11 and 13.

The invention includes a method for manufacturing the illuminated sports board riser 3, 6, 7, 12, 14, 18 and 21 described above. First a transparent/translucent plane 7 and 12 is provided. The plane is molded or tooled to accommodate the components 8, 10, 11 and 13 of the riser 3, 6, 7, 12, 14, 18 and 21. The light source 8, on/off switch 10 and power source 11 are connected to the electrical circuit 13 as described: connect the positive connection of power source 11 to the on/off switch 10 and from the on/off switch 10 to the positive connection of the light source then from the negative connection of the light source 8 to the negative connection of power source 11 to complete the electrical circuit 13. In the electrical circuit 13 the connections could be reversed; connect the negative connection of power source 11 to the on/off switch 10 and from the on/off switch 10 to the negative connection of the light source then from the positive connection of the light source 8 to the positive connection of power source 11 to complete the electrical circuit 13. Once assembled the components 8, 10, 11 and 13 are placed into the transparent/translucent plane 7 and 12. Finally the assembled components 8, 10 and 13 are sealed into the riser using a translucent/transparent material such as resin or silicon and the material is allowed to harden.

While the invention has been described with reference to at least one preferred embodiment, it is to be clearly understood by those skilled in the art that the invention is not limited thereto. Rather, the scope of the invention is to be interpreted only in conjunction with the appended claims.

What is claimed is:

1. An illuminated sports board riser comprising:
a translucent or transparent plane;
an LED light source(s);
a power switch controlling power to light source(s);
a power source controlled through the power switch;
an electric circuit connecting the power source to the switch;
an electric circuit connecting the power switch to the light source(s);
a translucent or transparent resin or other material to seal the electrical components;
a removable or non-removable cover to seal the power source;

2. The illuminated sports board riser of claim 1 comprising a method to allow the riser to be rotated in relation binding mounting plates.

3. The illuminated sports board riser of claim 1 comprising a method to allow the riser to be mounted below a sports board between the components used to move over the surface below the sports board and the sports board.

4. The illuminated sports board riser of claim 1 wherein the riser is built into the sports board.

5. The illuminated sports board riser of claim 1 wherein the power switch controls one or more risers.

6. A method for manufacturing an illuminated sports board riser; the method comprising the steps of:
a) providing a translucent or transparent plane tooled or molded to accommodate components, power source(s) and switch(s);
b) providing an LED light source(s);
c) providing a power switch located between a power source and light source(s);
d) providing a power source controlled through the power switch;
e) providing an electric circuit and connecting the power source to the switch;
f) providing an electric circuit and connecting the power switch to the light source(s);
g) providing a translucent or transparent resin or other material to seal the electrical components;
h) covering light source(s), electrical circuits and non-movable parts of power switch with resin or or other material; and if needed
i) allowing the resin or other material to harden;
j) providing a removable or non-removable cover to seal the power source;
